(19) United States
(12) Patent Application Publication
(10) Pub. No.: US 2018/0254805 A1
(43) Pub. Date: Sep. 6, 2018

(54) EXTENSIBLE WIFI MIMO CHANNEL MAPPING WITH MMWAVE REMOTE RADIO HEAD

(71) Applicant: INTEL IP CORPORATION, Santa Clara, CA (US)

(72) Inventors: Ali S. SADRI, San Diego, CA (US); Carlos H. ALDANA, Santa Clara, CA (US); Liang XIAN, Portland, OR (US)

(21) Appl. No.: 15/447,751

(22) Filed: Mar. 2, 2017

(51) Int. Cl. H04B 7/0413; H04B 7/08; H04B 1/00; H01Q 5/28; H04B 7/06

(52) U.S. Cl. CPC H04B 7/0413; H04B 7/086; H04W 84/12; H01Q 5/28; H04B 7/0617; H04B 1/0096

(57) ABSTRACT

One aspect provides an extensible architecture that can optionally utilize an Intel® WiFi chipset and a mmWave Modular Antenna Array (MAA) technology to develop an extensible system that is capable of operating at multiple mmWave bands by connecting to different mmWave capable Remote Radio Heads (RRH). The end result of one exemplary aspect will be a low cost distribution network for both access and backhaul extending the industries proven WiFi technology thus enabling mmWave MAAs to be developed within a short period of time.

### TECHNICAL FIELD

An exemplary aspect is directed toward communications systems. More specifically an exemplary aspect is directed toward wireless communications systems and even more specifically to next generation wireless networks. Even more particularly, an exemplary aspect is directed toward channel mapping with remote radio heads (intelligent and/or simple).

### BACKGROUND

For example, but not by way of limitation, common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to IEEE 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

IEEE 802.11ac and other standards have proposed full duplex WiFi radios that can simultaneously transmit and receive on the same channel using standard WiFi 802.11ac PHYs. These radios achieve close to the theoretical doubling of throughput in all practical deployment scenarios. The IEEE 802.11ac-2013 update, or IEEE 802.11ac Wave 2, is an addendum to the original IEEE 802.11ac wireless specification. IEEE 802.11ac Wave 2 utilizes MU-MIMO (Multi-User-Multi-Input Multi-Output) technology and other advancements to help increase theoretical maximum wireless speeds from 3.47 Gbps to 6.93 Gbps in IEEE 802.11ac Wave 2.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary small cell network topology;

FIG. 2 illustrates bands that can be used for communications;

FIG. 3 illustrates a block diagram of components of a WiFi architecture for mmWave band operation;

FIG. 4 illustrates bands in 5 GHz WiFi channels;

FIG. 5 illustrates another block diagram of components of a WiFi architecture for mmWave band operation;

FIG. 6 illustrates a third block diagram of components of a WiFi architecture for mmWave band operation;

FIG. 7 illustrates a fourth block diagram of components of a WiFi architecture for mmWave band operation;

FIG. 8 illustrates an exemplary communications device that can be used with the techniques disclosed herein; and

FIG. 9 is a flowchart illustrating an exemplary method for channel mapping.

### DESCRIPTION OF EMBODIMENTS

Data usage increases exponentially year over year and the traditional macro cell architecture may no longer be scalable with higher data demands. Consequently, by utilizing smaller cell topology one can increase network capacity significantly for next generation communications systems or 5G.

It is also known that 5G systems can utilize both the licensed and unlicensed bands as well as lower microwave and higher mmWave frequency bands. WiFi is known to be a proven technology for data communications. There is no limitation of WiFi technology that prevents the technology from operating in other frequency bands. To that effect, one can assume and demonstrate that a WiFi architecture can operate in both unlicensed and/or licensed bands. Consequently, one solution may deploy the licensed WiFi in standalone mode or utilize a LWA (LTE/WLAN Aggregation) architecture for both collocated and non-collocated topologies. It is also known that due to mmWave propagation characteristics and different regulatory regimes, 5G systems typically utilize multiple frequency bands for data transmissions.

One exemplary embodiment takes advantage of the best of both WiFi technology, mmWave radios and RFEMs (Radio Front End Module(s)) to extend the usability of communications technology.

One aspect provides an extensible architecture that can optionally utilize an Intel® WiFi chipset and a mmWave Modular Antenna Array (MAA) technology to develop an extensible system that is capable of operating at multiple mmWave bands by connecting to different mmWave capable Remote Radio Heads (RRH) in a modular manner as needed. Remote Radio Heads are becoming more prevalent with base station architectures. RRHs typically comprise a base station's RF circuits/components and analog-to-digital converters, digital-to-analog converters and up/down converters. RRHs are usually connected to the base station via an optical link and associated interface. RRHs typically support several wireless standards and corresponding technologies. FPGAs are customarily used for RRH functionalities such as digital up conversion, digital down conversion, crest factor reduction and digital pre-distortion as well as one or more of the other technologies discussed herein.

While exemplary embodiments may be discussed in relation to particular standards, it is to be appreciated that the technology discussed herein is also applicable to other standards provided they are based on an N×N MIMO system. Effectively, an exemplary aspect breaks the system in to 2×2 s. So if there is an 8×8 system, that system can be broken down into 4 2×2 systems with H (Horizontal) and V (Vertical) polarization for each pair. Thus, the architecture is easily scaled and adaptable to different implementations.

The end result of one exemplary aspect will be a low cost distribution network for both access and backhaul extending the industries proven WiFi technology thus enabling mmWave MAAs to be developed within a short period of time.

As will be seen herein, one aspect can optionally use the Intel® Wave500 chipset (or in general any modem) with a network processor, such as the optional Intel® GRX350 network processor, and optional Puma platform (which is a family of modem technologies) utilizing mmWave MAAs, although in general any MAA can be used as will be appreciated from the description herein.

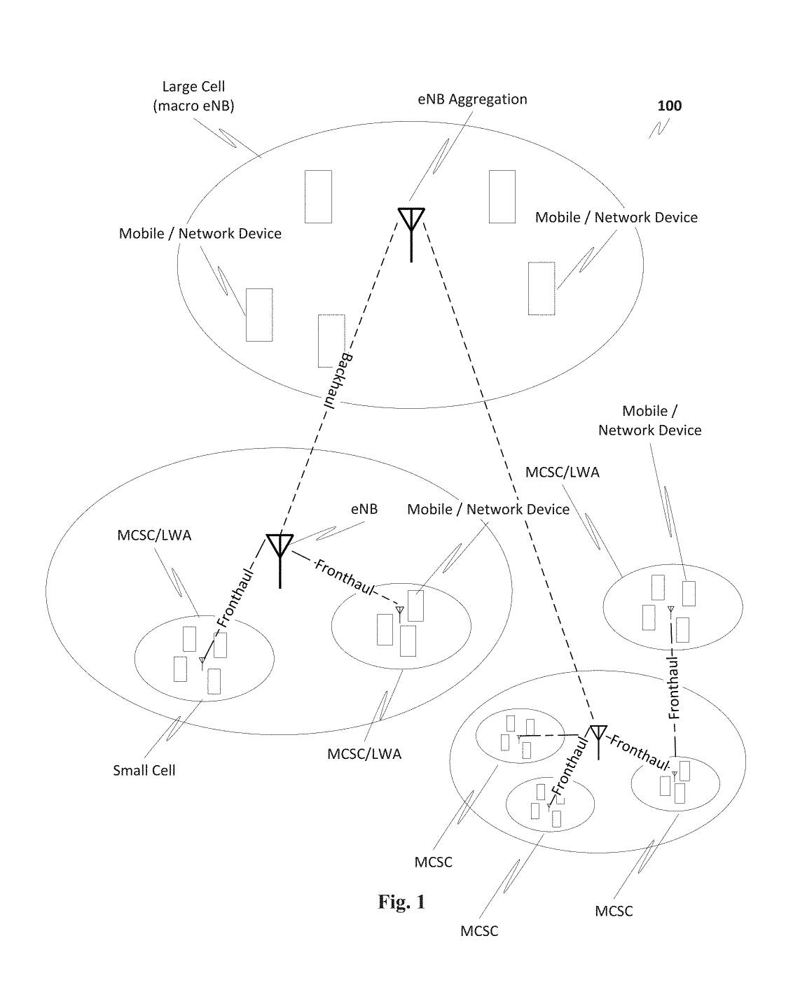

FIG. 1 illustrates an exemplary top level macro-micro system topology 100 utilizing mmWave capable small cells operating standalone or in collaboration with the existing LTE systems embodied as a LWA architecture. For example, in FIG. 1, a HetNet with mmWave capable small cells (MCSC) is shown. In FIG. 1, one element of the LTE Radio Access Network eNB aggregates over a backhaul information from other eNBs on the fronthaul. The heterogeneous network with large and small cells as shown in FIG. 1 can include one or more large cells, with each large cell typically having a higher-power eNB, and a plurality of smaller cells, with the smaller cells typically having a lower-powered base station or remote radio head, providing hot-spot coverage, providing coverage at the cell edge of the large cell, providing coverage in an area not covered by the macro network, providing indoor coverage, providing indoor coverage and/or providing off-load for one or more larger cells.

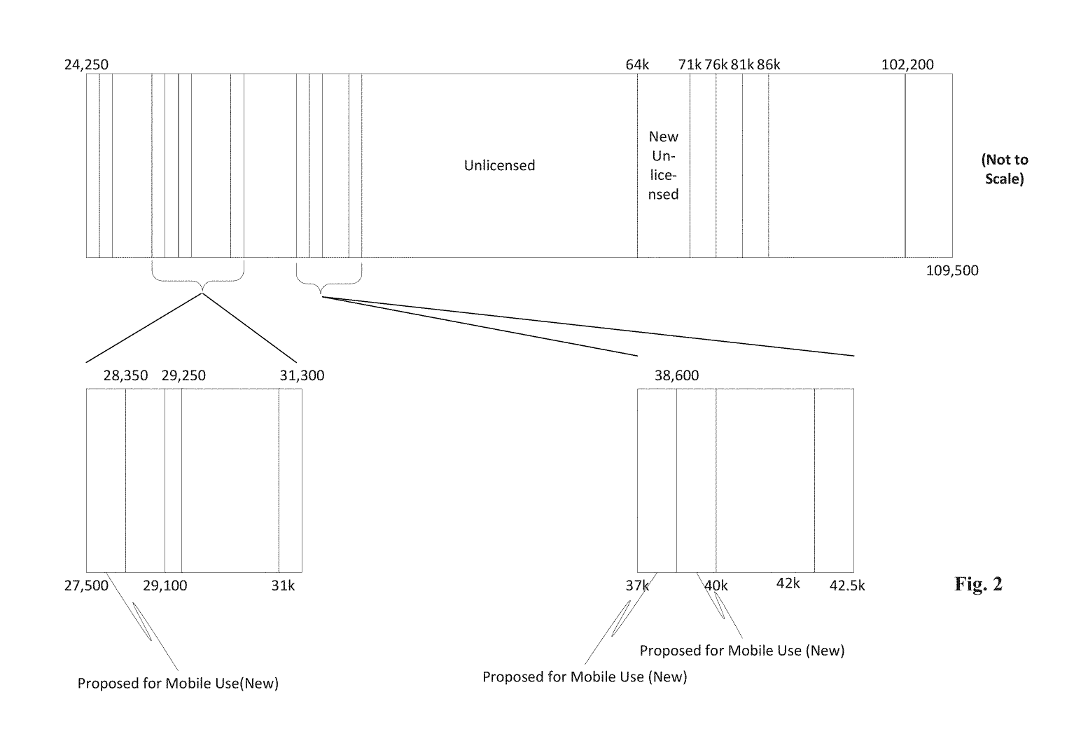

Recently the FCC (Federal Communications Commission) announce an extension to the available frequency bands that includes several bands in the mmWave frequency regions. FIG. 2 shows the latest mmWave band allocation for use in the 5G systems. In FIG. 2, the bands marked as “new” are denoted as new allocations.

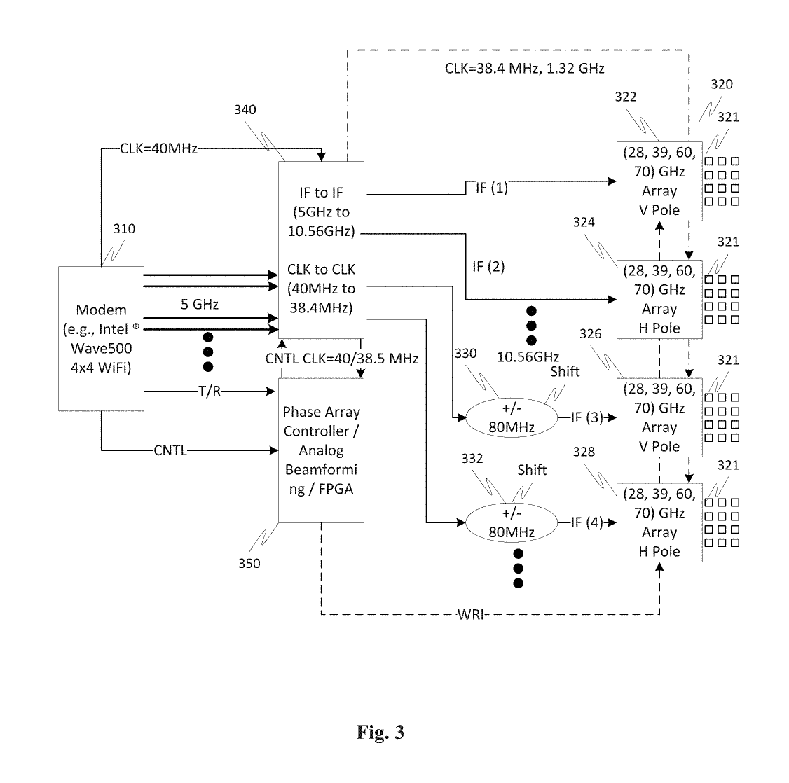

As discussed, an exemplary aspect is directed toward a single architecture that can utilize all available frequency bands with a simple and proven extensible architecture. FIG. 3 shows a single architecture that is capable of using well-known WiFi technology, up converting the analog output to the center frequency of the IF (Intermediate Frequency) used for the input to the mmWave array at the desired operating frequency.

More specifically, in this exemplary aspect, a 4×4 WiFi system (modem) 310 feeds the mmWave MAA 320 which includes in this example 4 radio heads 322, 324, 326 and 328 and associated respective antenna arrays. Due to the characteristics of the mmWave signal and the beamforming requirements of the system, the 4×4 MIMO outputs of the WiFi system 310 are mapped as two 2×2 systems (one set of outputs eventually output by radio heads 322 and 324, and the other set of outputs eventually output by radio heads 326 and 328, after having been frequency converted and shifted by the frequency shifters 330, 332) and then connected to the vertical and horizontal radio heads 322/326 and 324/328, respectively.

The first MIMO pair is output by the modem 310 to the frequency converter 340 (which can be for example an intermediate frequency to intermediate frequency converter, capable of converting 5GHz, 10 GHz, 9 GHz, 10.56 GHz, or in general any frequency to any frequency). In this aspect, the modem outputs at 5GHz which is then up converted by the frequency converter 340 to match the frequency of the antenna array 320, which is here 10.56 GHz. This first up converted MIMO pair of the streams (here the upper 2 streams output by modem 310) are then output after frequency conversion as IF(1)/IF(2) to the vertical pole radio head 322 and horizontal pole radio head 324, respectively.

The second MIMO pair (the lower 2 streams output by modem 310) are similarly up converted by the frequency converter 340 to the IF frequency of the array with additional shifting of the carrier performed by the shifters 330/332 by the bandwidth of the 2×2 system. This exemplary configuration uses an 80 MHz capable WiFi system that effectively can produce 2 streams of 80 MHz channels to map the 4×4 system. For example, the signal that becomes IF(3) can be shifted up or down by 80 MHz and the signal that becomes IF(4) is shifted opposite that of IF(3). As one example, IF(3) is shifted +80 MHz and IF(4) is shifted −80 MHz, however it is to be appreciated that the shifting can be any amount.

Thus, thus use of the vertical and horizontal polarization, coupled with the shifting of the lower 2 streams, occupies 160 MHz. This can be important in that when the 4 streams leave the modem 310, they have a random distribution. However, this random distribution can be lost after the IF to IF conversion. By introducing the horizontal and vertical polarization (2×2 MIMO) at the radio heads coupled with the +/− shifting (additional 2×2 MIMO), the random distribution (4×4 MIMO) is maintained. If for example there is line-of-site (LOS) between the system and a device, the +/− shifting can optionally be eliminated in that there may be sufficient randomness such that the shifting is not required. 2×2 is optional for LOS with 2 streams, and in accordance with one aspect the system can decide based on the environment (such as interference, feedback, QoS, and/or the like) whether or not to also use the +/− shifting as shown in FIG. 3.

The modem 310 is also capable of outputting a control signal (CNTL) that can be used by the phase array controller 320 is assist with, for example, beamforming in the array. The antenna array can operate at any frequency(ies), and in accordance with this aspect is shown as capable of operating at 28 GHz, 39 GHz, 60 GHz and 70 GHz. Each array is also capable of being intelligent and selecting an operating frequency, for example based on one or more of interference, feedback, QoS, or any other common metric, and has a plurality of antennas 321 as discussed herein.

While the frequency converter 340 is discussed in accordance with this aspect as being an IF to IF converter, the frequency converter could alternatively be an IF to RF converter. For example, the frequency could up convert a 5GHz input to a 28 GHz output. This could be especially useful where the radio heads are not intelligent and the 28 GHz output is used by the radio heads.

One exemplary advantage of the architecture as shown in FIG. 3, is that the system is capable of operation in any band with a single architecture. This can be of further benefit in terms of reducing costs, complexity and increasing extensibility to, for example, technologies beyond 4×4 MIMO and/or at different frequencies.

In the FIG. 3 architecture, the modem 310 is also optionally connected to a phase array controller 350 which is capable of performing analog beamforming and can be embodied as a FPGA and/or micro controller (uController). The phase array controller can output a signal (WRI) that can control the radio heads 322-328 and associated respective antenna arrays. The modem 310, in addition to optionally performing digital beamforming and outputting 4×4 MIMO in accordance with this aspect, can also output a clock signal which can similarly and optionally be converted as needed by the frequency converter 340 before being sent to the radio heads/antennas 321, 322-328, which can also be referred to as a phase array.

In the aspect shown in FIG. 3, the modem 310 outputs at 5GHz and the input to the radio heads is 10.56 GHz. However, it should be appreciated that the output of the modem 310 can be at any frequency, and similarly the inputs to the radio heads can be at any frequency, and can even be the same as shown hereafter.

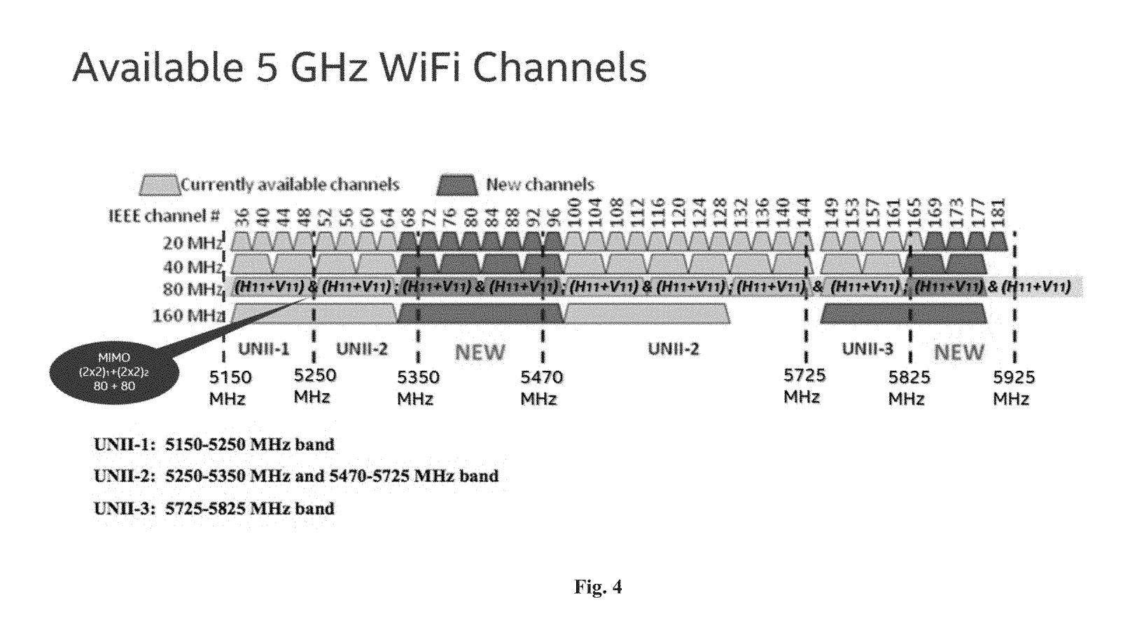

FIG. 4. illustrates the channelization of the 80 MHz+80 MHz up converted to the 10.56 GHz IF frequency as shown in FIG. 3.

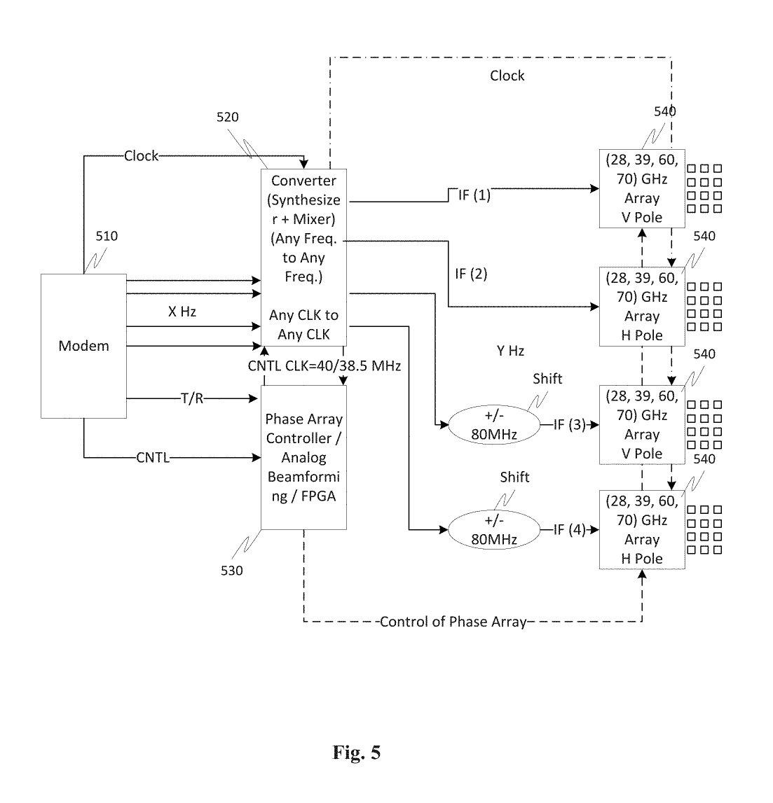

FIG. 5 illustrates another aspect of an extensible architecture for WiFi MIMO channel mapping with radio heads. This architecture is similar to that of FIG. 3 and includes modem 510, a converter 520, a phase array controller 530 and a plurality of radio heads 540. In this aspect, the converter 520 can be embodied as a synthesizer and/or a mixer and is capable of converting any output frequency of the plurality of streams (X Hz/kHz/MHz/GHz) from the modem 510 to any frequency (Y Hz/kHz/MHz/GHz) for the array 540. Additionally, the converter 520 is capable of optionally converting the incoming clock signal to any frequency clock signal(s) as appropriate for the phase array controller 530 and/or the radio heads 540.

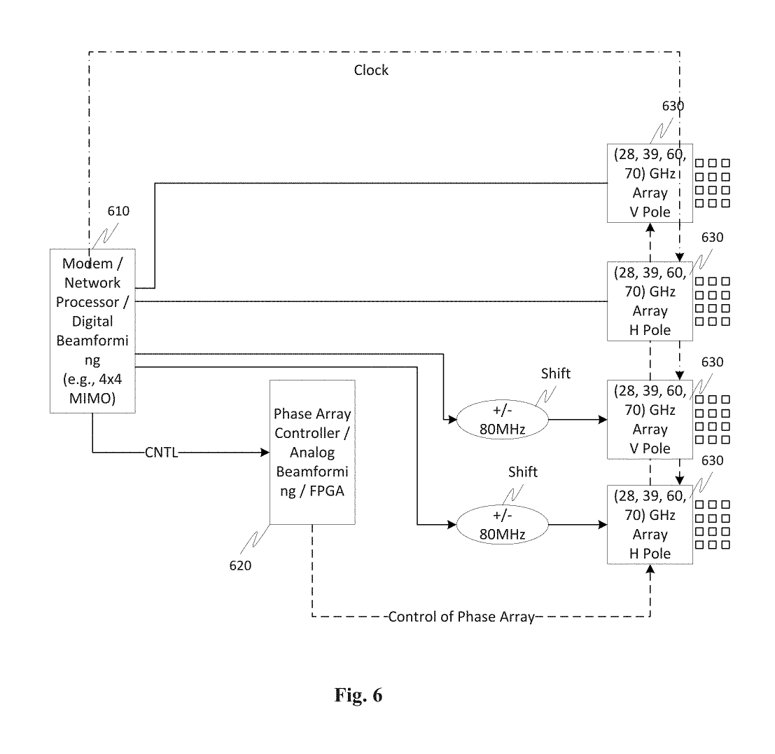

FIG. 6 illustrates another aspect of an extensible architecture for WiFi MIMO channel mapping with radio heads. This architecture is also similar to that of FIG. 3 and includes modem/network processor 610, a phase array controller 520 and a plurality of radio heads 540. However, for this aspect a converter is not needed in that the output frequency of the modem 610 is matched to that of the radio heads 630. While any frequency is possible, the modem 610 could output the 4 MIMO streams at 10.56 GHz, which is directly compatible with the radio heads 630. Alternatively, the radio heads 630 can perform frequency conversion in the radio head itself for example as part of the functionality of the RF chip. Similar to FIG. 3, the modem 610 can also perform digital beamforming and the phase array controller 620 can perform analog beamforming.

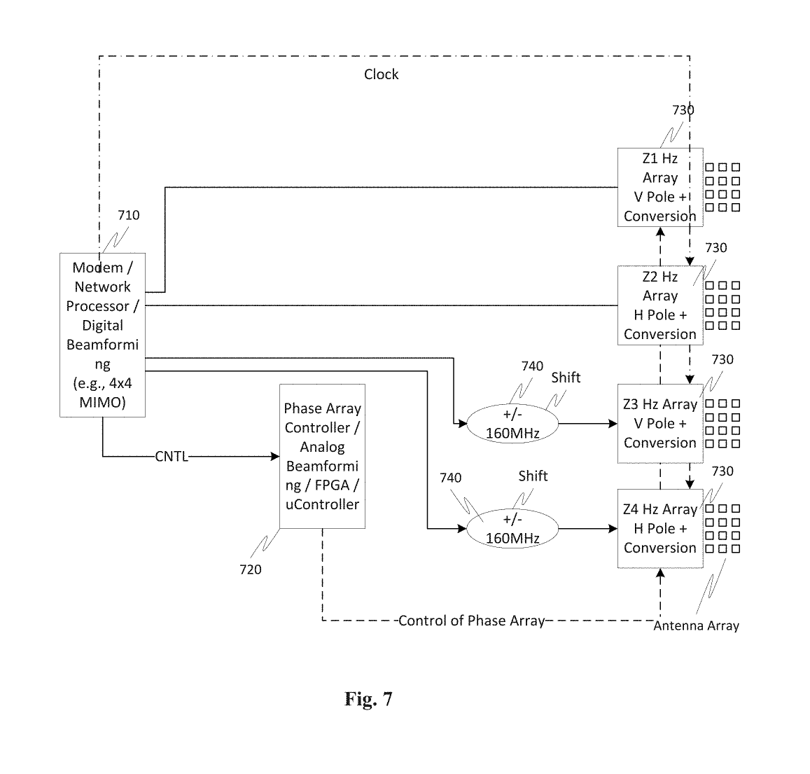

FIG. 7 illustrates another aspect of an extensible architecture for WiFi MIMO channel mapping with multi-frequency radio heads. This architecture is also similar to that of FIG. 3 and includes modem/network processor 710, an optional phase array controller 720 and a plurality of multi-frequency radio heads 730. However, for this aspect, the radio heads can operate at any frequency as indicated by Z1-Z4 Hz/kHz/MHz/GHz in the figure. Additionally, in this aspect, which illustratively occupies 320 MHz, the shift is +/−160 MHz. In this example, the system is using a 160 Mhz capable WiFi that effectively can produce 2 streams of 160 MHz channels to map to the 4×4 MIMO system. Also in this system, the clock frequency is the same for all components, thereby not needing any conversion.

Exemplary aspects capitalize on mmWave system design, MAA architecture and proven WiFi technology by developing a single architecture that can enable mmWave connectivity at Gbps rate for both access and backhaul usages. The aspects can also leverage extensible RF and RFEMs at 28, 39, and 60 GHz bands to provide a low cost and quick deployment for enabling pre-5G deployment using standard WiFi chipsets, mmWave RFEMs and technology for access points and home gateways.

In the detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc. WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec., 2012); IEEE-802.11REVmc (“IEEE 802.11-REVmcTM/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, or operate using any one or more of the above protocols, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a

Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth , Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

Some demonstrative embodiments may be used in conjunction with a WLAN (Wireless Local Area Network), e.g., a WiFi network. Other embodiments may be used in conjunction with any other suitable wireless communication network, for example, a wireless area network, a “piconet”, a WPAN, a WVAN, and the like.

Some demonstrative embodiments may be used in conjunction with a wireless communication network communicating over a frequency band of 5 GHz and/or 60 GHz. However, other embodiments may be implemented utilizing any other suitable wireless communication frequency bands, for example, an Extremely High Frequency (EHF) band (the millimeter wave (mmWave) frequency band), e.g., a frequency band within the frequency band of between 20 Ghz and 300 GHZ, a WLAN frequency band, a WPAN frequency band, a frequency band according to the WGA specification, and the like.

While the above provides just some simple examples of the various device configurations, it is to be appreciated that numerous variations and permutations are possible. Moreover, the technology is not limited to any specific channels, but is generally applicable to any frequency range(s)/channel(s). Moreover, and as discussed, the technology may be particularly useful in the unlicensed spectrum.

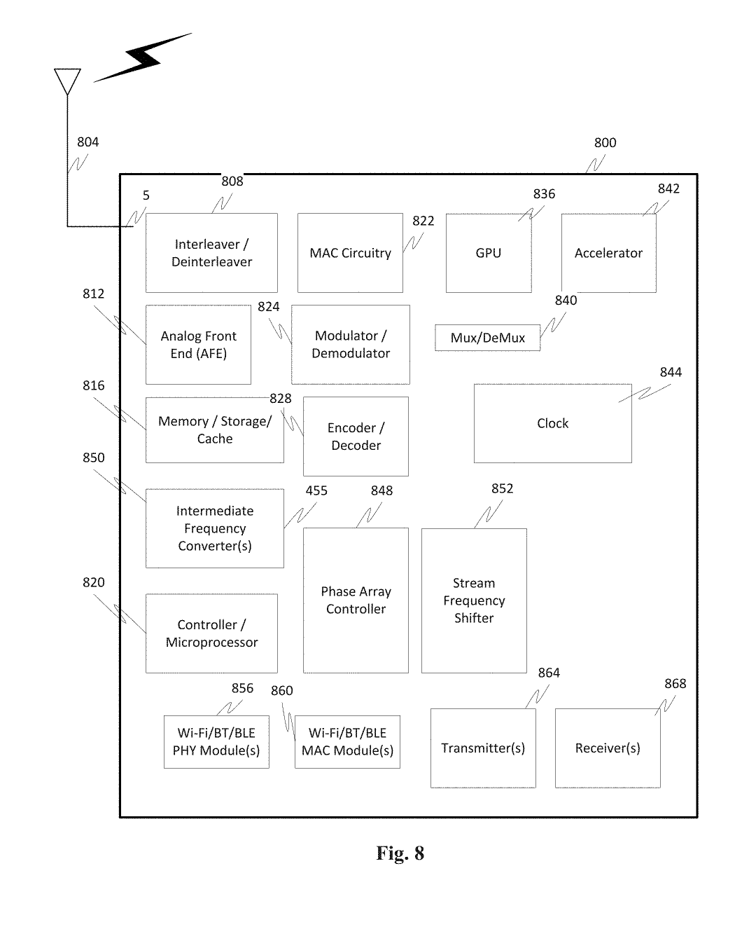

FIG. 8 illustrates an exemplary hardware diagram of a device 800, such as the device shown in FIG. 3, a wireless device, mobile device, access point, station, and/or the like, that is adapted to implement the technique(s) discussed herein. Operation will be discussed in relation to the components in FIG. 8 appreciating that each separate device in a system, e.g., station, AP, proxy server, etc., can include one or more of the components shown in the figure, with the components each being optional and each capable of being collocated or non-collocated.

In addition to well-known componentry (which has been omitted for clarity), the device 800 includes interconnected elements (with links 5 generally omitted for clarity) including one or more of: one or more antennas/antenna arrays 804, an interleaver/deinterleaver 808, an analog front end (AFE) 812, memory/storage/cache 816, controller/microprocessor 820, MAC circuitry 822, modulator/demodulator 824, encoder/decoder 828, GPU 836, accelerator 842, a multiplexer/demultiplexer 840, clock 844, phase array controller 848, an intermediate frequency converter 850, stream frequency shifter 852, a Wi-Fi/BT/BLE (Bluetooth®/Bluetooth® Low Energy) PHY module 856, a Wi-Fi/BT/BLE MAC module 860, transmitter(s) 864 and receiver(s) 868. The various elements in the device 800 are connected by one or more links (not shown, again for sake of clarity).

The device 800 can have one more antennas 804, for use in wireless communications such as multi-input multi-output (MIMO) communications, multi-user multi-input multi-output (MU-MIMO) communications Bluetooth®, LTE, RFID, 4G, 5G, LTE, LWA, etc. The antenna(s) 804 can include, but are not limited to one or more of directional antennas, omnidirectional antennas, monopoles, patch antennas, loop antennas, microstrip antennas, dipoles, multi-element antennas, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 804 generally interact with the Analog Front End (AFE) 812, which is needed to enable the correct processing of the received modulated signal and signal conditioning for a transmitted signal. The AFE 812 can be functionally located between the antenna and a digital baseband system in order to convert the analog signal into a digital signal for processing and vice-versa.

The device 800 can also include a controller/microprocessor 820 and a memory/storage/cache 816. The device 800 can interact with the memory/storage/cache 816 which may store information and operations necessary for configuring and transmitting or receiving the information described herein and/or operating the device as described herein. The memory/storage/cache 816 may also be used in connection with the execution of application programming or instructions by the controller/microprocessor 820, and for temporary or long term storage of program instructions and/or data. As examples, the memory/storage/cache 820 may comprise a computer-readable device, RAM, ROM, DRAM, SDRAM, and/or other storage device(s) and media.

The controller/microprocessor 820 may comprise a general purpose programmable processor or controller for executing application programming or instructions related to the device 800. Furthermore, the controller/microprocessor 820 can perform operations for configuring and transmitting information as described herein. The controller/microprocessor 820 may include multiple processor cores, and/or implement multiple virtual processors. Optionally, the controller/microprocessor 820 may include multiple physical processors. By way of example, the controller/microprocessor 820 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 800 can further include a transmitter(s) 864 and receiver(s) 868 which can transmit and receive signals, respectively, to and from other wireless devices and/or access points using the one or more antennas 804. Included in the device 800 circuitry is the medium access control or MAC Circuitry 822. MAC circuitry 822 provides for controlling access to the wireless medium. In an exemplary embodiment, the MAC circuitry 822 may be arranged to contend for the wireless medium and configure frames or packets for communicating over the wireless medium as discussed.

The PHY module/circuitry 856 controls the electrical and physical specifications for device 800. In particular, PHY module/circuitry 856 manages the relationship between the device 800 and a transmission medium. Primary functions and services performed by the physical layer, and in particular the PHY module/circuitry 856, include the establishment and termination of a connection to a communications medium, and participation in the various process and technologies where communication resources shared between, for example, among multiple STAs. These technologies further include, for example, contention resolution and flow control and modulation or conversion between a representation of digital data in user equipment and the corresponding signals transmitted over the communications channel. These are signals are transmitted over the physical cabling (such as copper and optical fiber) and/or over a radio communications (wireless) link. The physical layer of the OSI model and the PHY module/circuitry 856 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 822 handle co-ordination of interactions between the MAC and PHY layers.

The MAC layer and components, and in particular the MAC module 860 and MAC circuitry 822 provide functional and procedural means to transfer data between network entities and to detect and possibly correct errors that may occur in the physical layer. The MAC module 850 and MAC circuitry 822 also provide access to contention-based and contention-free traffic on different types of physical layers, such as when multiple communications technologies are incorporated into the device 800. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 800 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 842 can cooperate with MAC circuitry 822 to, for example, perform real-time MAC functions. The GPU 836 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

The intermediate frequency converter 850 as discussed can handle the conversion from any frequency to any intermediate frequency. As discussed, the intermediate frequency converter 850 can handle frequency discrepancies between modem components and the radio heads. The phase array controller 848 can be embodied as a micro controller, FPGA, or the like, and is adapted to perform analog beamforming for the antenna arrays. The stream frequency shifter 852 shifts the frequency of one or more of the streams output by the modem components as discussed. The various elements/components in FIG. 8 cooperate to perform the functionality as discussed herein.

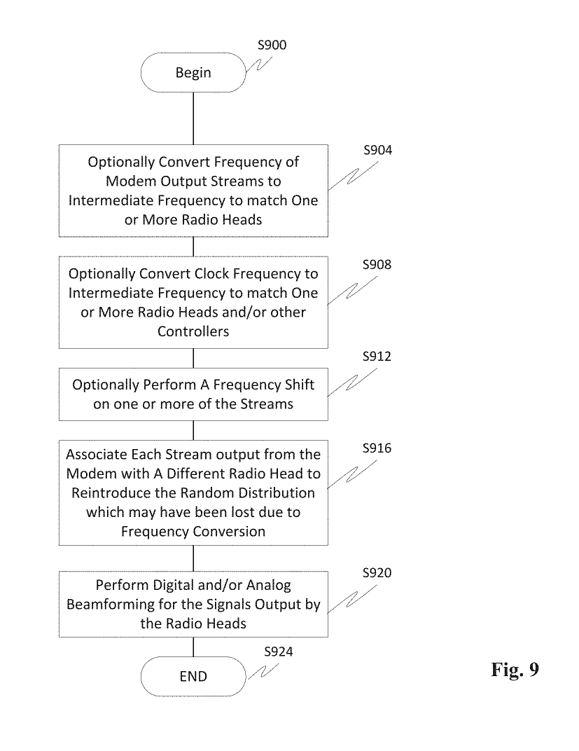

FIG. 9 outlines an exemplary method for channel mapping to mmWave remote radio heads. In particular control begins in step S900 and continues to step S904. In step S904, the frequency of one or more modem output streams is optionally converted to match one or more radio heads. Next, in step S908, the clock frequency can be converted to match one or more radio heads and/or other controllers. Then, in step S912, a frequency shift can be performed for one or more of the streams output by the modem components. Control then continues to step S916.

In step S916, each stream output from the modem is associated with a different radio head. Next, in step S920, one or more of analog and digital beamforming is applied to the signals output by one or more of the radio heads. Control then continues to step S924 where the control sequence ends.

In yet another aspect, the communications system can be described as comprising a N×N MIMO system wherein the output of the system is split into 2×2 s, or viewed another way, an M×M system is split into X modular 2×2 systems with Horizontal and Vertical polarization for each respective 2×2 modular pair and N, M and X are integers. Therefore, as an example of the modularity and scalability, an 8×8 MIMO system of streams from a MIMO modem is converted into 4, 2×2 systems, each of the 4 2×2 systems having horizontal and vertical polarization radio heads and associated antenna arrays. (See as an example the ellipses in FIG. 3) This modularity and scalability is applicable to any of the embodiments/aspects disclosed herein.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A WiFi system comprising:

a modem to output a plurality of multiple-input multiple-output streams at a frequency;

a plurality of radio heads; and

a plurality of shifters, wherein individual streams of a first set of the plurality of streams are sent to respective ones of a first portion of the plurality of radio heads, and individual streams of a second set of the plurality of streams are shifted by a frequency and sent to respective ones of a second portion the plurality of radio heads.

Any of the above aspects, further comprising a phase array controller to perform analog beamforming for the plurality of radio heads.

Any of the above aspects, further comprising an intermediate frequency to intermediate frequency converter to convert the frequency of the plurality of multiple-input multiple-output streams to an input frequency of the plurality of radio heads.

Any of the above aspects, further comprising a radio frequency chip in one of the plurality of radio heads to convert the frequency of one multiple-input multiple-output stream to an input frequency of a radio head.

Any of the above aspects, further comprising a clock frequency converter.

Any of the above aspects, wherein the modem is a 4×4 WiFi system.

Any of the above aspects, wherein the plurality of radio heads are mmWave capable modular antenna arrays (MAA).

Any of the above aspects, wherein a portion of the plurality of radio heads are horizontal polarization and a second portion of the plurality of radio heads are vertical polarization.

Any of the above aspects, wherein each of the plurality of radio heads are associated with a respective antenna array.

Any of the above aspects, wherein the modem further performs digital beamforming for the plurality of radio heads.

A non-transitory information storage media having stored thereon one or more instructions, that when executed by one or more processors, cause a channel mapping method comprising:

associating each output stream from a modem with a different radio head;

performing digital beamforming at each radio head;

performing analog beamforming at each radio head; and

performing a frequency shift on a portion of the output streams from the modem.

Any of the above aspects, further comprising performing a frequency conversion on each output stream.

Any of the above aspects, further comprising converting a clock frequency to a second clock frequency.

Any of the above aspects, further comprising performing digital beamforming.

Any of the above aspects, further comprising performing analog beamforming.

Any of the above aspects, further comprising performing an intermediate frequency conversion on each output stream.

Any of the above aspects, wherein the modem is a WiFi modem.

Any of the above aspects, wherein the radio heads are remote radio heads.

Any of the above aspects, further comprising associating a first output stream with a vertical polarization radio head and a second output stream with a horizontal polarization radio head.

A multi-band wireless communications device comprising:

means for associating each output stream from a modem with a different radio head;

means for performing digital beamforming at each radio head;

means for performing analog beamforming at each radio head; and

means for performing a frequency shift on a portion of the output streams from the modem.

Any of the above aspects, further comprising means for performing analog beamforming for the plurality of radio heads.

Any of the above aspects, further comprising means for converting the frequency of the plurality of multiple-input multiple-output streams to an input frequency of the plurality of radio heads.

Any of the above aspects, further comprising means for, in one of the plurality of radio heads, to convert the frequency of one multiple-input multiple-output stream to an input frequency of a radio head.

Any of the above aspects, further comprising means for a clock frequency conversion.

Any of the above aspects, wherein the modem is a 4×4 WiFi system.

Any of the above aspects, wherein the plurality of radio heads are mmWave capable modular antenna arrays (MAA).

Any of the above aspects, wherein a portion of the plurality of radio heads are horizontal polarization and a second portion of the plurality of radio heads are vertical polarization.

Any of the above aspects, wherein each of the plurality of radio heads are associated with a respective antenna array.

Any of the above aspects, wherein the modem further performs digital beamforming for the plurality of radio heads.

A communications system comprising: a N×N MIMO system wherein the system is split into 2×2 s, such that an M×M system is broken into X 2×2 systems with Horizontal and Vertical polarization for each 2×2 pair and N, M and X are integers.

Any of the above aspects, wherein an 8×8 system of streams is converted into 4, 2×2 systems, each of the 4 systems having a horizontal and a vertical polarization pair output by respective radio heads.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA.™. or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A WiFi system comprising:
a modem to output a plurality of multiple-input multiple-output streams at a frequency, the modem modularly connectable to one of a plurality of remote mmWave
radio heads, the modem capable of operating at multiple mmWave bands by connecting to different ones of the plurality of remote mmWave radio heads; and
a plurality of shifters, wherein individual streams of a first set of the plurality of streams are sent to respective ones of a first portion of the plurality of radio heads, and individual streams of a second set of the plurality of streams are shifted by a frequency and sent to respective ones of a second portion of the plurality of radio heads.

2. The system of claim 1, further comprising a phase array controller to perform analog beamforming for the plurality of radio heads.

3. The system of claim 1, further comprising an intermediate frequency to intermediate frequency converter to convert the frequency of the plurality of multiple-input multiple-output streams to an input frequency of the plurality of radio heads.

4. The system of claim 1, further comprising a radio frequency chip in one of the plurality of radio heads to convert the frequency of one multiple-input multiple-output stream to an input frequency of a radio head.

5. The system of claim 1, further comprising a clock frequency converter.

6. The system of claim 1, wherein the modem is a 4×4 WiFi system.

7. The system of claim 1, wherein the plurality of radio heads are mmWave capable modular antenna arrays (MAA).

8. The system of claim 1, wherein a portion of the plurality of radio heads are horizontal polarization and a second portion of the plurality of radio heads are vertical polarization.

9. The system of claim 1, wherein each of the plurality of radio heads are associated with a respective antenna array.

10. The system of claim 1, wherein the modem further performs digital beamforming for the plurality of radio heads.

11. A non-transitory information storage media having stored thereon one or more instructions, that when executed by one or more processors, cause a channel mapping method comprising:
associating each output stream from a modem with a different remote mmWave radio head, the modem being modularly connectable to one of a plurality of remote mmWave radio heads, the modem adapted to operate at multiple mmWave band by connecting to different ones of the plurality of remote mmWave radio heads;
performing digital beamforming at each radio head;
performing analog beamforming at each radio head; and
performing a frequency shift on a portion of the output streams from the modem.

12. The media of claim 11, further comprising performing a frequency conversion on each output stream.

13. The media of claim 11, further comprising converting a clock frequency to a second clock frequency.

14. The media of claim 11, further comprising causing a phase array controller to perform digital beamforming.

15. The media of claim 11, further comprising causing a phase array controller to perform analog beamforming.

16. The media of claim 11, further comprising performing an intermediate frequency conversion on each output stream.

17. The media of claim 11, wherein the modem is a WiFi modem.

18. The media of claim 11, wherein the radio heads are remote radio heads.

19. The media of claim 11, further comprising associating a first output stream with a vertical polarization radio head and a second output stream with a horizontal polarization radio head.

20. A multi-band wireless communications device comprising:
means for associating each output stream from a modem with a different remote mmWave radio head, the modem being modularly connectable to one of a plurality of remote mmWave radio heads, the modem adapted to operate at multiple mmWave bands by connecting to different ones of the plurality of remote mmWave radio heads;
means for performing digital beamforming at each radio head;
means for performing analog beamforming at each radio head; and means for performing a frequency shift on a portion of the output streams from the modem.
